(19) United States
(12) Patent Application Publication
(10) Pub. No.: US 2007/0063613 A1
(43) Pub. Date: Mar. 22, 2007

(54) Thermoelastically actuated microresonator

(75) Inventors: David Elata, Haifa (IL); Rashed Mahameed, Aum-El-Fahm (IL)

Correspondence Address: PEARL COHEN ZEDEK, LLP;PEARL COHEN ZEDEK LATZER, LLP, 1500 BROADWAY 12TH FLOOR, NEW YORK, NY, 10036, US

(73) Assignee: TECHNION RESEARCH AND DEVELOPMENT FOUNDATION LTD., HAIFA (IL)

(21) Appl. No.: 10/556,033

(22) PCT Filed: May 9, 2004
(86) PCT No.: PCT/IL04/00391

§ 371 Date: Nov. 8, 2005

Related U.S. Application Data
(60) Provisional application No. 60/469,460, filed on May 9, 2003.

(51) Int. Cl. H02N 10/00

(52) U.S. Cl. 310/306

(57) ABSTRACT

A thermoelastically actuated microresonator device comprising: a main body (14) having a cantilevered beam (12); a heating element (20) located adjacent a surface of the cantilevered beam and adjacent the main body, that may be periodically actuated to generate a periodic heat gradient across a height of the beam, thereby facilitating periodic deflection of the beam.

### FIELD OF THE INVENTION

The present invention relates to Micro-Electro-Mechanical-Systems (MEMS) resonators. More particularly, the present invention relates to dynamic thermoelastic actuation of micro-resonators allowing large deflection amplitudes.

### BACKGROUND OF THE INVENTION

Micro-Electro-Mechanical-Systems (MEMS) is the general name used to refer to systems integrating mechanical elements, actuators, sensors and electronics on a silicon substrate, manufactured using microfabrication technologies. See, for example U.S. Pat. No. 6,720,267 (Chen et al.), U.S. Pat. No. 6,621,390 (Song et al,), U.S. Pat. No. 6,531,668 (Ma).

Current state-of-the-art electrostatic actuation suffers from nonlinearity, geometric limitations on deflection (due to small gaps between the electrodes of deformable capacitors), and high damping that requires vacuum packaging. In contrast, current state-of-the-art thermoelastic actuation methods are free of these limitations. Nevertheless, current state-of-the-art thermoelastic actuation methods suffer from a lengthy response time that restricts their usefulness for driving high frequency resonators.

Electrostatic actuation is the most prevalent means of driving MEMS devices. The advantages of electrostatic actuators are that they can be readily constructed using standard microfabrication technology, and characteristically they have a relatively large power density. Due to the inherent nonlinear nature of electrostatic forces, the electromechanical response of electrostatic actuators is nonlinear, and the device may become unstable. This poses difficulties in driving and controlling such devices. To achieve a high power density without reverting to the use of high voltages, gaps between the electrodes of the actuator must be minimal. These small gaps make it difficult to achieve high amplitude of the dynamic deflection. Furthermore, decreasing the gaps not only intensifies the nonlinear effects, but also induces high damping of the dynamic response. To sufficiently reduce the damping, many electrostatic resonators must be sealed in a vacuum, which presents manufacturing and packaging difficulties (see U.S. Pat. No. 6,350,983 (Kaldor et al.)). To enable large deflection amplitudes, complex geometries must be used which complicate the fabrication process.

In contrast, existing thermoelastic actuation schemes, exhibit a more linear response, and far less damping. This is primarily because small gaps are not required around the deformable structure. However, existing thermoelastic actuators suffer from a relatively slow response. This disadvantage is primarily because much time is required to heat up large regions of the actuator, which then have to be cooled down—mostly by conduction.

Thermoelastic actuators offer a simple means of driving Microsystems and they can be readily fabricated using standard materials and micromachining processes. The prevalent state-of-the-art thermoelastic actuation schemes are: a hot/cold arm structure (see FIG. 1a); a bimorph structure (FIG. 1b); and a thermal buckling structure (FIG. 1c). In these actuation schemes, selected structural elements are heated up to a desired actuation temperature. The thermal expansion of homogeneous elements or the thermally induced flexure of inhomogeneous elements, are utilized to achieve the required motion.

The hot/cold arm thermal actuator (FIG. 1a) consists of two parallel arms (2, 4) of different cross-section thickness, connected at their end (see R. S. Chen, C. Kung and G.-B. Lee, “Analysis of the optimal dimension on the electrothermal microactuator”, Journal of Micromechanics and Microengineering, Vol. 12, pp. 291-296, 2002). The hot arm 2 is preferably thinner than the cold arm 4, and therefore has a higher electrical resistance than that of the cold arm. When a voltage difference is applied between the clamped edges of the two arms, the current density in the thin arm 2 is larger than in the thick arm 4. The energy dissipated by the electric current heats the arms of the actuator. Due to the difference in thickness (resistance), the thin arm heats up more than the cold arm. The difference in the thermal expansion between the two arms induces a deflection of the entire structure (see R. Hickey, D. Sameoto, T. Hubbard and M. Kujath, “Time and frequency response of two-arm micromachined thermal actuators”, Journal of Micromechanics and Microengineering, Vol. 13, pp. 40-46, 2003, and U.S. Pat. No. 6,531,947 (Weaver, et al.)).

The bimorph actuator (FIG. 1b) consists of a cantilever beam that is made of two materials (6, 8) with a different thermal expansion coefficient. For example, a vertical bimorph actuator can be constructed from a silicon beam that is side-coated with aluminum (see H. Sehr, A. G. R. Evans, A. Brunnschweiler, G. J. Ensell and T. E. G. Niblock, “Fabrication and test of thermal vertical bimorph actuators for movement in the wafer plane”, Journal of Micromechanics and Microengineering, Vol. 11, pp. 406-410, 2001, and U.S. Pat. No. 6,067,797 (Silverbrook et al.)). When the structure is heated, the difference in thermal expansion coefficient induces bending of the structure (see H. Sehr, I. S. Tomlin, B. Huang, S. P. Beeby, A. G. R. Evans, A. Brunnschweiler, G. J. Ensell, C. G. J. Schabmueller and T. E. G. Niblock, “Time constant and lateral resonances of thermal vertical bimorph actuators”, Journal of Micromechanics and Microengineering, Vol. 12, pp. 410-413, 2002).

The thermal buckling actuator (FIG. 1c) consists of a series of thin straight legs that are nearly parallel (FIG. 1c). When these legs (9) are heated (either internally by an electric current or by an external heater), they expand. The direction of the thermally induced buckling is determined by a small initial angle provided between the legs. By increasing the number of legs, the output force of the actuator can be amplified. Also, by using longer legs the displacement of the movable shuttle can be extended (see C. D. Lott, T. W. Mclain, J. N. Harb, L. L. Howell, “Modelling the thermal behaviour of a surface-micromachined linear-displacement thermomechanical microactuator”, Journal of Sensors and Actuators A, Vol. 101, pp. 239-250, 2002, U.S. Pat. No. 5,955,817 (Dhuler et al.), and U.S. Pat. No. 6,114,794 (Dhuler et al.).

In existing thermoelastic actuation schemes the driving forces are fully developed only when the thermoelastic elements have been heated to the required actuation temperature. Termination of the driving forces requires cooling of these elements (e.g., by conduction). Due to the thermal relaxation time, the response of these actuators is slow relative to other actuation methods (e.g., electrostatic actuation).

In the present invention it will be shown that by utilizing the spatial gradient of temperature rather than temperature itself, a much higher actuation frequency can be achieved.

The present invention concept was previously examined by Lammerink et al. (see T. S. J. Lammerink, M. Elwenspoek, and J. H. J. Fluitman, “Frequency Dependence of Thermal Excitation of Micromechanical Resonators,” Sensors and Actuators A, vol. 25-27, pp. 685-689, 1991), and Boustra et al. (see S. Bouwstra, J. v. Roijen, H. A. C. Tilmans, A. Selvakumar, and K. Najafi, “Thermal base drive for micromechanical resonators employing deep-diffusion bases,” Sensors and Actuators A, vol. 37-38, pp. 38-44, 1993).

In theses previous studies the temperature field was modeled as one-dimensional and several conclusions were derived. The performance predicted from these investigations was not very promising and it seems that the concept has been mostly neglected since. Specifically, in these previous studies—due to the one-dimensional analysis—it was concluded that the heater location and heater length have no effect on the performance of the actuator. In this respect, the two-dimensional analysis presented in this disclosure provides new insight and enables design optimization of the novel actuation concept. The two dimensional analysis shows that the heater location and length have a strong affect on the system performance.

In the present invention, a two-dimensional analysis of the actuation scheme is performed. This analysis leads to new insight and new conclusions. The two-dimensional modeling enables to conduct a parametric analysis and optimize the actuator to achieve large edge deflections.

It is an aim of the present invention to provide a novel thermoelastic actuator device with enhanced response.

Yet another aim of the present invention is to provide a novel thermoelastic actuator device, with enhanced deflection capabilities.

Another aim is to present a methodology for optimizing the geometrical parameters of the novel thermoelastic actuator.

Other features and advantages of the present invention will be clearly appreciated after reading the present invention and reviewing the accompanying drawings.

### SUMMARY OF THE INVENTION

There is thus provided, in accordance with some preferred embodiments of the present invention, a method for thermoelastic actuation of a microresonator consisting of a main body having a cantilevered beam with a suspended proof mass, the method comprising:

generating periodically a heat flux locally over a surface of the cantilever beam adjacent the main body;

whereby the beam and the suspended proof mass are made to vibrate at the frequency corresponding to the period of the supplied heat flux.

Furthermore, in accordance with some preferred embodiments of the present invention, the frequency of the generated heat gradient is determined by the vibration frequency of the beam.

Furthermore, in accordance with some preferred embodiments of the present invention, actuation is monitored by a piezoelectric sensing.

Furthermore, in accordance with some preferred embodiments of the present invention, the heat gradient is achieved by applying a heat flux in a square waveform.

Furthermore, in accordance with some preferred embodiments of the present invention, there is provided a thermoelastically actuated microresonator device comprising:

a main body having a cantilevered beam;

a heating element adjacent a surface of the cantilevered beam and adjacent the main body, that may be periodically actuated to generate a periodic heat heat gradient across a height of the beam,

thereby facilitating periodic deflection of the beam.

Furthermore, in accordance with some preferred embodiments of the present invention, the heating element is located on a surface adjacent the main body.

Furthermore, in accordance with some preferred embodiments of the present invention, the device is fabricated in micromachining techniques.

Furthermore, in accordance with some preferred embodiments of the present invention, the main body and the beam are made from a silicon layer.

Furthermore, in accordance with some preferred embodiments of the present invention, the device is made using silicon on insulator (SOI) technology.

Furthermore, in accordance with some preferred embodiments of the present invention, the heating element is patterned from a metallization layer.

Furthermore, in accordance with some preferred embodiments of the present invention, the metallization layer is made from metal selected from the group consisting: Chrome, Platinum, and Gold.

Furthermore, in accordance with some preferred embodiments of the present invention, wherein the heating element is a resistor.

Furthermore, in accordance with some preferred embodiments of the present invention, heating is achieved by radiation from an external source.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1a illustrates a thermoelastic actuation scheme in the form of a hot/cold arm.

FIG. 1b illustrates a thermoelastic actuation scheme in the form of a bimorph structure.

FIG. 1c illustrates a thermoelastic actuation scheme in the form of a thermal buckling structure.

FIG. 2 illustrates a schematic view of a thermoelastic microresonator, in accordance with a preferred embodiment of the present invention.

FIG. 3 is a diagram showing the progression in temperature distribution in the beam of the microresonator shown in FIG. 2, under the heater. Several time points tᵢ (tᵢ+1>tᵢ) during a single load cycle are considered.

FIG. 4 is a charted illustration of the frequency response of the microresonator of FIG. 2—free edge deflection and phase shift relative to the heat flux.

FIG. 5 The resonance edge deflection amplitude as function of the location of the heater resistor.

FIG. 6 The temperature at the center of the heater, as function of time for different resistor locations.

FIG. 7 The resonance edge deflection amplitude as function of the resistor length.

FIG. 8 shows experimental numerical results of edge deflection as function of input voltage.

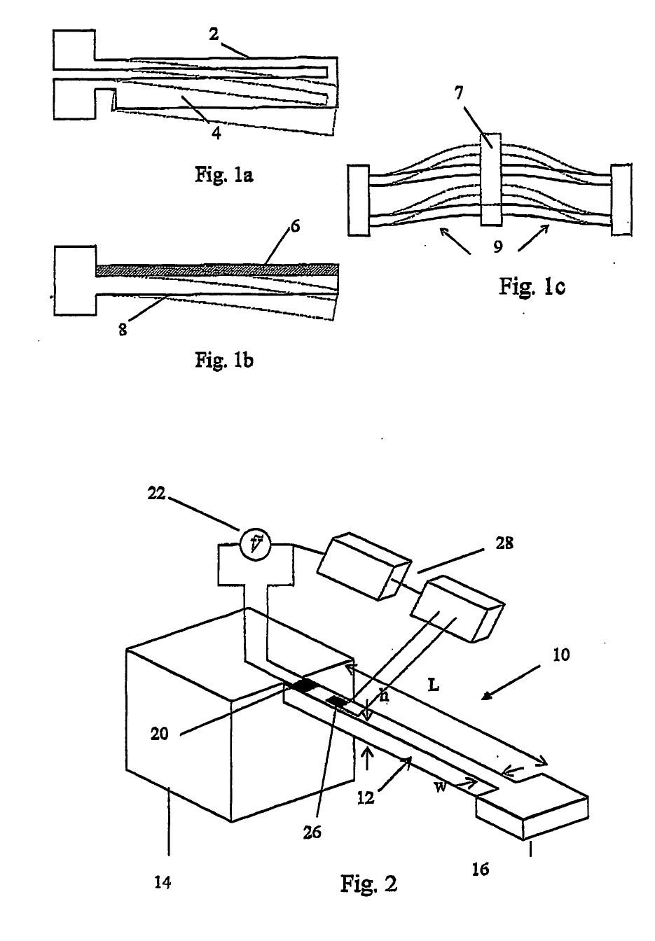

### DETAILED DESCRIPTION OF PREFERRED EMBODIMENTS

The novel thermoelastic actuation device in accordance with the present invention is characterized by a much shorter response time. In contrast to existing thermoelastic actuators, the driving forces in the novel actuation scheme are induced by local gradients of temperature. These gradients fully develop within a time scale that is much shorter than the time required to heat or cool an entire thermoelastic element.

The novel thermoelastic actuation scheme enables higher frequencies than can be achieved by using existing thermoelastic actuation schemes on structures of comparable dimensions.

Like other thermoelastic actuation schemes (prior art), the novel scheme has considerable advantages over electrostatic actuation. Namely, the novel scheme does not suffer from the inherent nonlinearities associated with electrostatic actuation, and the deflection in the novel scheme is not limited by small surrounding gaps. Accordingly, the novel actuation scheme does not suffer from high damping that requires vacuum packaging.

The specific simulated example presented hereinafter demonstrates that large deflection amplitudes may be achieved.

In essence, a main aspect of the present invention is the provision of a novel thermoelastic actuator device, featuring the use of induced temperature gradient over a portion of the cantilever, as the actuating factor, preferably adjacent the main body of the microresonator, at the connection zone with the beam.

The novel thermoelastic actuation scheme is demonstrated on a microresonator 10 (see FIG. 2). A voltage source 22 connected to a resistive heater 20, which periodically supplies heat over a confined region of the upper surface of a deformable cantilever beam 12, with a suspended proof mass 16. The heater is positioned adjacent to the anchor 14, which is the body the beam is attached to, also serving as a heat sink. The heater may be positioned at other locations along the beam, but the closer it is to the main body the greater deflection that may be achieved. An optional piezoresistive element 26 enables the measurement of the actual frequency of the resonator, but this measurement may take different forms too. A feedback control 28 determines the heat flux frequency.

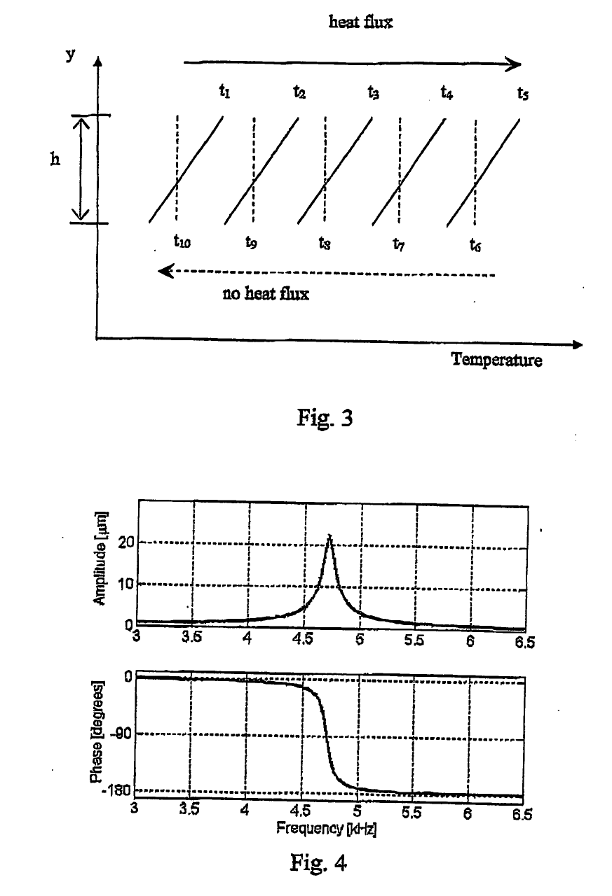

The stable periodic temperature distribution that develops under the heater in accordance with a preferred embodiment of the present invention is schematically illustrated in FIG. 3, for a square waveform of supplied heat flux. Note that this waveform is given as an example only and in no way limits the scope of the present invention. In fact it is asserted that almost any other waveform with a periodically changing gradient may be suited for the job.

A temperature gradient rapidly develops as heat is supplied, and, in accordance to the nature of the waveform in this example, maintains a constant amplitude whereas the temperature continuously increases. When the heat supply is stopped, the temperature gradient rapidly vanishes whereas temperature continuously decreases.

The temperature gradient under the heater induces a gradient in the thermal stress across the beam height h. The gradient in thermal stress gives rise to an internal bending moment. This internal moment is proportional to the heat flux and is instantaneously activated and terminated. Periodic variations in this internal moment induce steady vibrations of the beam.

By tuning the frequency of the heat flux wave-form to the natural frequency of the cantilevered beam, a resonance response may be achieved. To achieve this, the actual frequency of the resonator may be measured for example by using the piezoresistive element 26 on the upper surface of the beam (see FIG. 2).

The temperature gradient under the heater is proportional to the supplied heat flux. This gradient across the beam of height h, is generated within a time scale of the order τₕ=h²/α where α is the thermal diffusivity of the structure material. In contrast, in the existing thermoelastic actuation schemes the thermoelastic elements have to be heated to the actuation temperature along their entire length L, and then cooled down. This heating and cooling process characteristically occurs over a time scale of τ_{L}=L²/α. Typically, the ratio between the height and length of thermoelastic actuator beams is h/L≈ 1/100. Therefore, applying temperature gradient across the beam height for actuation has the potential of reducing the thermal response time by four orders of magnitude relative to existing schemes (τₕ/τ_{L}≈10⁻⁴).

To demonstrate the novel actuation scheme in accordance with a preferred embodiment of the present invention, and investigate its performance, the dynamic response of a microresonator beam was simulated. The results presented herein relate to a thin Aluminum beam with the following dimensions (see FIG. 2): L=800 [μm], h=10 [μm], w=100 [μm], m=2.710⁻⁹ [kg]. The microresonator was subjected to a periodic heat flux with maximal amplitude of q=6.4 10⁸ [W/m2].

The dynamic response was simulated with the ANSYS™ finite element code using coupled-field harmonic analysis. The maximal deflection at the free edge of the beam was computed assuming a damping ratio of ξ=0.01 and neglecting convection.

The deflection amplitude as function of the frequency of the supplied heat flux is illustrated in FIG. 4. The resonance frequency of the system is 4.72 [kHz], and it is slightly larger than the free vibration frequency of the system because the beam is elongated due to the heating. The resonance amplitude is 22 [μm], and in the vicinity of the clamped edge of the beam the maximal von Mises stress is 78 [MPa] and the maximal temperature is 90 [° C] over ambient temperature.

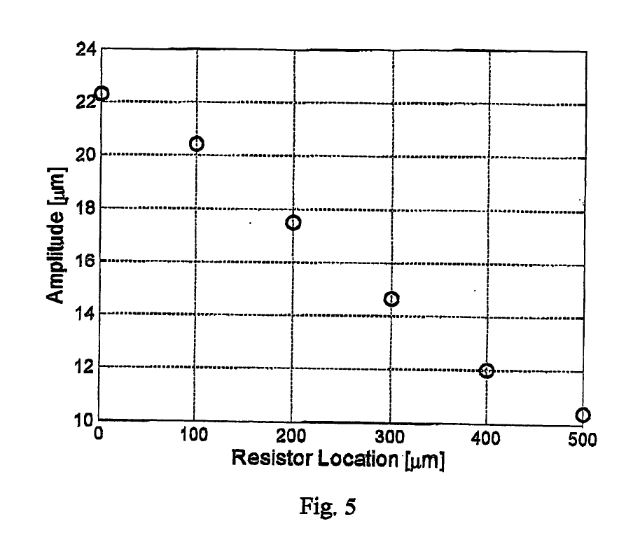

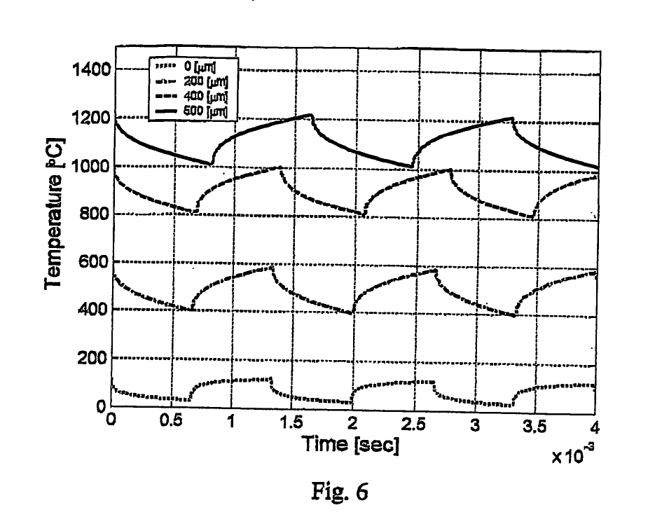

As shown in FIG. 5 the resonance amplitude when the resistor is located near the anchor is ≈22 [μm] whereas the displacement when the resistor is located in the middle of the beam is half of this value. FIG. 6 presents the temperature at the center of the heater as function of time. In contrast to the resonance deflection, the maximal temperature under the heater increases with increasing distance between the resistor and the anchor. The maximal temperature associated with the first heater location (closest to the anchor) is 120° C. above the ambient temperature. In contrast, the maximal temperature when the heater is located at the center of the beam is as high as 1220° C. The maximal temperature is a design restriction as various failure mechanisms (e.g., electro-migration and melting of the resistor material) are strongly affected by temperature.

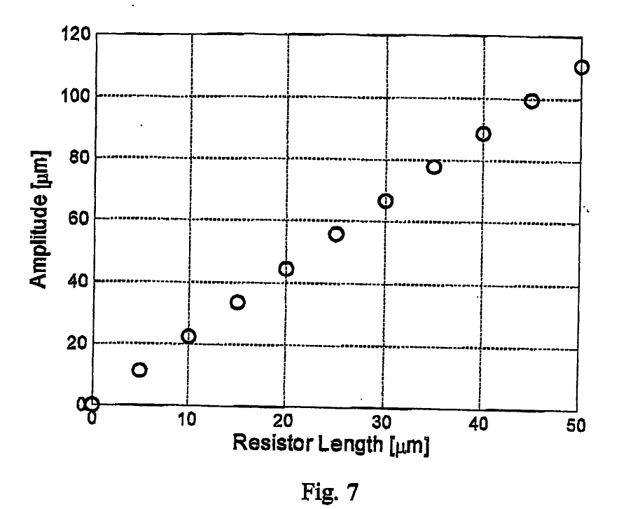

As presented in FIG. 7, the resonance edge deflection in small resistive heater lengths is linearly proportional to the resistive heater length. For large resistive heaters the resistive heater length will be not efficient and the edge deflections converge. However, this increase in edge deflection is associated with an increase of the maximal temperature under the heater.

The affects of heater location and of heater length discussed above, were not observed in previous studies that were based on a one-dimensional (vertical) analysis of the temperature field. In this respect, the two-dimensional analysis provides new insight and enables design optimization of the novel actuation concept.

For this thermoelastic resonator, the thermal time scale across the beam height is τₕ=1 [μs], which suggests that it may be driven in frequencies of up to f≈0.5 [MHz].

Note that the figures given hereinabove are merely an example an in no way constitute specific limitations to the scope of the present invention.

To confirm the predicted performance of the novel thermoelastic resonator, several test devices were fabricated. The different resonators were micromachined from a 10 μm thick layer of Single-Crystal Silicon (SCS) using silicon on insulator (SOI) technology. The structures were constructed from a beam with width w=100 [μm] and a rectangular edge mass with a width of wₘ=600 [μm].

The resistor and pads were patterned from a metallization layer of 30 [nm] Chrome, 100 [nm] Platinum, and 100 [nm] Gold. A square waveform voltage was supplied to the serpentine shaped resistor by probes that were in contact with the pads. The vertical deflection of the cantilever beam was measured in several points with a Polytec Laser Vibrometer.

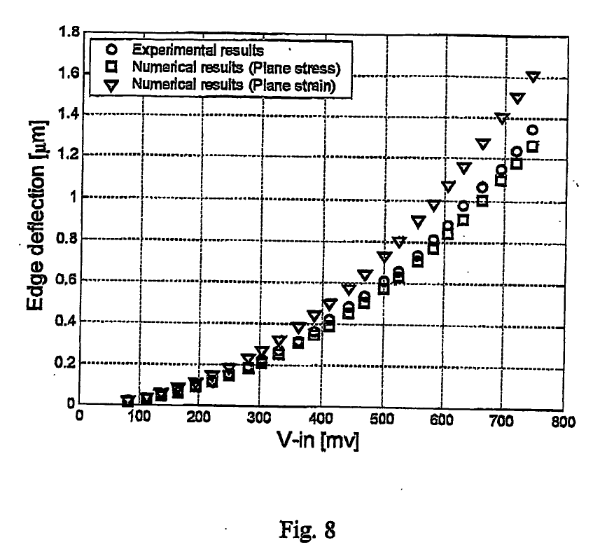

Measured edge deflection of specific structure is presented in FIG. 8. The deflection is found to be a parabolic function of the voltage (or a linear function of the supplied heat flux). This relation was predicted by an analytic solution of the two-dimensional temperature field in a system with a simplified geometry.

The three-dimensional nature of the system was not considered in present simulation. Nevertheless, FIG. 8 presents a simulated response of a microresonator in accordance with a preferred embodiment of the present invention, showing that the measured deflection is between the simulated predictions that assume plain stress and plain strain responses, respectively.

It is noted that a person skilled in the art, after reading the present specification and viewing the accompanying drawings would be able to make various changes and modifications to the proposed scheme that would still be covered by the scope of the present invention.

It should be clear that the description of the embodiments and attached Figures set forth in this specification serves only for a better understanding of the invention, without limiting its scope.

1. A method for thermoelastic actuation of a microresonator consisting of a main body having a cantilevered beam with a suspended proof mass, the method comprising of:
generating periodically a heat flux locally over a surface of the cantilever beam adjacent the main body;
whereby a temperature gradient is periodically generated in the beam in the vicinity of the main body;
and whereby the beam and the suspended proof mass are made to vibrate at the frequency corresponding to the period of the supplied heat flux.

2. The method of claim 1, wherein the frequency of the generated heat gradient is determined by the vibration frequency of the beam.

3. The method of claim 1, wherein actuation is monitored by a piezoelectric sensing.

4. The method of claim 1, wherein the heat gradient is achieved by applying a heat flux in a square waveform.

5. A thermoelastically actuated microresonator device comprising:
a main body having a cantilevered beam;
a heating element located a surface of the cantilevered beam, that may be periodically actuated to generate a periodic heat gradient across a height of the beam,
thereby facilitating periodic deflection of the beam.

6. The device of claim 5, wherein the heating element is located on a surface adjacent the main body.

7. The device of claim 5, wherein it is fabricated in micromachining techniques.

8. The device of claim 5, wherein the main body and the beam are made from a silicon layer.

9. The device of claim 8, wherein it is made using silicon on insulator (SOI) technology.

10. The device of claim 8, wherein the heating element is patterned from a metallization layer.

11. The device of claim 10, wherein the metallization layer is made from metal selected from the group consisting: Chrome, Platinum, and Gold.

12. The device of claim 5, wherein the heating element is a resistor.

13. A method for thermoelastic actuation of a microresonator substantially as described in the present specification, accompanying drawings and appending claims.

14. A thermoelastically actuated microresonator substantially as described in the present specification, accompanying drawings and appending claims.
